(19) United States
(12) Patent Application Publication
(10) Pub. No.: US 2008/0066648 A1
(43) Pub. Date: Mar. 20, 2008

(54) HIGH WATER-REPELLENT COMPOSITION

(76) Inventors: Koichi Asakura, Yokohama-shi (JP); Akihiro Kuroda, Yokohama-shi (JP); Naoki Shibata, Yokohama-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/857,643

(22) Filed: Sep. 19, 2007

(30) Foreign Application Priority Data
Sep. 19, 2006 (JP) 2006-252616
Sep. 3, 2007 (JP) 2007-227523

(51) Int. Cl. C09D 119/00

(52) U.S. Cl. 106/287.16; 106/287.1

(57) ABSTRACT

A high water-repellent composition includes: a ultrafine pigment whose surface is treated with a monooctyl silane and whose primary particle diameter is in a range of 1 nm to 15 μm, a silicone resin and/or liquid silicon rubber, and a volatile solvent. The content of the ultrafine pigment surface-treated with monooctyl silane is in a range of 40 to 80 percent by weight relative to the weight of the composition excluding the volatile solvent.

### BACKGROUND OF THE INVENTION

1. Field of the Invention

An embodiment of the present invention relates to a composition that can easily add a surface exhibiting super water repellency or high water repellency characteristics simply by coating the base material with the composition or soaking it in the composition and then drying the base material.

Specifically, an embodiment of the present invention relates to a high water-repellent composition comprising a ultrafine pigment whose surface is treated with monooctyl silane and whose primary particle diameter is in a range of 1 nm to 15 μm, a silicone resin and/or liquid silicone rubber, and a volatile solvent, wherein the content of the ultrafine pigment surface-treated with monooctyl silane is in a range of 40 to 80 percent by weight relative to the weight of the composition excluding the volatile solvent.

2. Description of the Related Art

Traditionally, it is a common practice to blend water-repellent fine particles in materials used for making high water-repellent coating films. For example, Patent Literature 1 discloses a technique to provide a high water-repellent structure, whereby the surface of a mixture consisting of uniformly mixed polymer components and water-repellent fine particles is irradiated with laser to implement laser abrasion, and then the polymer components on the laser-irradiated surface and nearby areas are removed to expose the irregular surface constituted by water-repellent fine particles, so that the obtained structure exhibits excellent water repellency and is able to maintain such water repellency stably for a long period of time. In addition, Patent Literature 2 discloses a technique to provide a water-repellent paint, which is characterized by containing, as essential components, (A) metal oxide particles whose surface is uniformly fluorinated, (B) a silicone resin, and (C) friction-coefficient reducing agent.

On the other hand, Non-patent Literature 1 describes various liquid silicone rubbers. These descriptions suggest that liquid silicone rubbers, which offer excellent heat resistance, operability and adhesive property, are widely used in many industrial fields such as automobiles and sealing agents. Patent Literature 3 describes an application of ultrafine titanium dioxide where ultrafine titanium dioxide is added to silicone rubber. Patent Literature 4 provides a liquid silicone rubber composition for lubrication oil seal, where a fine calcium oxide powder or fine calcium hydroxide powder is blended by 10 to 40 parts by weight with a silicone composition of addition polymerization type to achieve high stability even in a degraded lubrication oil. Patent Literature 5 relates to a silicone rubber composition for electric wire sheath, characterized by comprising (A) an organo-polysiloxane crude rubber having an alkenyl group, (B) a fine silica powder, (C) an organo-hydrogen polysiloxane, (D) an alkyl organic peroxide, and (E) a spherical ultrafine catalyst constituted by a thermoplastic resin containing platinum catalyst, where a fine silica powder is blended at a high concentration, or specifically 10 to 100 parts by weight per 100 parts by weight of an organo-polysiloxane crude rubber. Patent Literature 6 describes heat-resistant fine silica particles, characterized by the coverage of particle surface by a material having heat resistance to silicone rubber, where the content of heat-resistant fine silica particles is 10 to 60 parts by weight per 100 parts by weight of silicone rubber.

[Patent Literature 1] Japanese Patent Laid-open No. 2005-179441

[Patent Literature 2] Japanese Patent Laid-open No. 2001-106973

[Patent Literature 3] Japanese Patent Laid-open No. 2006-265094

[Patent Literature 4] Japanese Patent No. 3522901

[Patent Literature 5] Japanese Patent Laid-open No. Hei 5-5062

[Patent Literature 6] Japanese Patent Laid-open No. 2002-161168

[Non-patent Literature 1] Chapter 10, “Liquid Silicone Rubbers” of “Silicone Handbook” edited by Kunio Ito, Nikkan Kogyo Shimbun (published Aug. 31, 1990)

### SUMMARY OF THE INVENTION

However, commonly-used traditional techniques involving blending of fine particles are mostly methods where high repellency is achieved by forming an irregular structure using other means such as laser, dies, etc., by improving the water repellency of coating film using fluorine materials, or by combining the foregoing, and no methods have been known to date where a coating film offering super water repellency or high water repellency can be obtained only by blending to an extremely high concentration a ultrafine pigment that has been given a specific surface treatment.

To solve these problems, the inventors found that super water repellency or high water repellency characteristics could be added with ease simply by coating the material with the composition described herein or soaking it in the composition and then drying the material, without providing a fine irregular structure, compounding with fluorine materials or using other method; wherein such composition is produced by combining: a ultrafine pigment whose primary particle diameter is in a range of 1 nm to 15 μm and whose surface is treated with monooctyl silane, which is a surface treatment agent offering excellent dispersion stability with respect to ultrafine pigments and also demonstrating high water repellency; a silicone resin and/or liquid silicone rubber; and a volatile solvent, where the content of the ultrafine pigment surface-treated with monooctyl silane is adjusted to a range of 40 to 80 percent by weight relative to the weight of the composition excluding the volatile solvent, thereby achieving a very high concentration of the surface-treated ultrafine pigment.

Embodiments of the invention described in the present application for patent consists of the first through fifth inventions specified below. However, it should be understood that the scope of the present invention is not limited to the embodiments described below.

The first embodiment of the invention covered by the present application for patent is a high water-repellent composition comprising at least one type of ultrafine pigment whose surface is treated with monooctyl silane and whose primary particle diameter is in a range of 1 nm to 15 μm, at least one type of silicone compound selected from silicone resin and/or liquid silicone rubber, and a volatile solvent, wherein the content of the ultrafine pigment surface-treated with monooctyl silane is in a range of 40 to 80 percent by weight relative to the weight of the composition excluding the volatile solvent.

The second embodiment of the invention covered by the present application for patent is a high water-repellent composition according to the first invention, wherein the liquid silicone rubber is selected from condensation liquid silicone rubbers.

The third embodiment of the invention covered by the present application for patent is a high water-repellent composition according to the first or second invention, wherein the silicone compound is a silicone resin expressed by the average formula RₙSiO(_{4-n)/2} where R is an organic group having an alkyl group of substituted or non-substituted type or linear or branched type and having a carbon number of 1 to 30, phenyl group, amino group, polyether group, sugar derivative, glyceryl group, polyglyceryl group, trifluoropropyl group or perfluoroalkyl group, and where the average number of n is in a range of 1 to 1.8.

The fourth embodiment of the invention covered by the present application for patent is a high water-repellent composition according to the first, second or third invention, wherein the high water-repellent composition is produced by mixing, at the time of use, a first liquid or paste composition that contains in a dispersed state at least one type of ultrafine pigment whose primary particle diameter is in a range of 1 nm to 15 μm and whose surface—is treated with monooctyl silane, and a second composition containing at least one type of silicone compound selected from a silicone resin and/or liquid silicone rubber.

The fifth embodiment of the invention covered by the present application for patent is a high water-repellent composition according to any one of the first to fourth embodiments, wherein the high water-repellent composition is a paint, ink, coating agent or sealant.

The present invention also includes a high water-repellent composition that uses a ultrafine pigment whose surface is treated with monooctyl silane to a range of 1 to 20 parts by weight per 100 parts by weight of ultrafine pigment.

In addition, the present invention includes a high water-repellent composition that blends a volatile solvent, wherein the volatile solvent has good compatibility with the silicone resin and/or liquid silicone rubber and exhibits excellent dispersibility with respect to the ultrafine pigment whose surface is treated with monooctyl silane.

As explained above, the high water-repellent composition proposed by an embodiment of the present invention can easily add super water repellency or high water repellency characteristics simply by coating the material with the composition described herein or soaking it in the composition and then drying the material, without providing a fine irregular structure, compounding with fluorine materials or using other method; wherein such composition is produced by combining: a ultrafine pigment whose primary particle diameter is in a range of 1 nm to 15 μm and whose surface is treated with monooctyl silane, which is a surface treatment agent offering excellent dispersion stability with respect to ultrafine pigments and also demonstrating high water repellency; a silicone resin and/or liquid silicone rubber; and a volatile solvent, where the content of the ultrafine pigment surface-treated with monooctyl silane is adjusted to a range of 40 to 80 percent by weight relative to the weight of the composition excluding the volatile solvent, thereby achieving a very high concentration of the surface-treated ultrafine pigment.

For purposes of summarizing the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### DETAILED DESCRIPTION OF THE PREFERRED EMBODIMENT

The aforementioned first through fifth embodiments of the inventions covered by the present application for patent are explained below in details.

The primary characteristic of an embodiment of the present invention is to provide a high water-repellent composition comprising a ultrafine pigment whose surface is treated with monooctyl silane and whose primary particle diameter is in a range of 1 nm to 15 μm, a silicone resin and/or liquid silicone rubber, and a volatile solvent, wherein the content of the ultrafine pigment surface-treated with monooctyl silane is in a range of 40 to 80 percent by weight relative to the weight of the composition excluding the volatile solvent.

Here, the monooctyl silane is a compound expressed by the general chemical structure formula RSi(R′)₃ (where R is an octyl group, while R′ is selected from alkoxys in alkyl groups with a carbon number of 1 to 6 such as methyl, ethyl, propyl or isopropyl as well as halogens such as chlorine). Among candidates, the ethoxy group is most favorable because of its safety, uniform treatment, and supply stability. Surface treatment methods that can be used include a method whereby a ultrafine pigment and monooctyl silane are mixed in dry state and then heated, a method whereby a ultrafine pigment and monooctyl silane are mixed in wet state by adding a solvent, etc., after which the solvent is removed and the remaining mixture is heated, and a method whereby a ultrafine pigment and monooctyl silane are mixed in wet state by adding a solvent, etc., and then dried by means of atomization. Among others, a method that uses a roll mill, bead mill or other dispersion apparatus capable of fine crushing in the wet mixing stage is preferable because agglutinated fine particles are crushed and consequently more uniform treatment can be achieved.

The amounts of ultrafine pigment and monooctyl silane to be used in the surface treatment should be adjusted preferably to a range of 1 to 20 parts by weight, or more preferably to a range of 2 to 15 parts by weight, of monooctyl silane relative to 100 parts by weight of ultrafine pigment. Since the amount of monooctyl silane required in the surface treatment of a ultrafine pigment varies depending on the specific surface area of the ultrafine pigment, the aforementioned parts-by-weight amounts of monooctyl silane should be regarded only as a general reference.

A ultrafine pigment that can be used under an embodiment of the present invention is characterized by having a primary particle diameter of 1 nm to 15 μm. If the primary particle diameter is less than 1 nm, the viscosity of the composition becomes too high and coating becomes difficult, which is undesirable. If the primary particle diameter exceeds 15 μm, on the other hand, improvement of water repellency becomes less likely. A desired method for evaluating the primary particle diameter is observation with an electron microscope. Acceptable shapes of ultrafine pigments include sphere, indeterminable, spindle, bar and sheet. Among others, pigments having a sphere, indeterminable or spindle shape are particularly preferable. The distribution of ultrafine pigment sizes is not specifically limited and the distribution can be wide or narrow. Ultrafine pigments used under an embodiment of the present invention may be either organic or inorganic pigments and can have a white color or any other color.

Examples of ultrafine pigments used under an embodiment of the present invention include titanium dioxide, zirconium oxide, zinc oxide, cerium oxide, magnesium oxide, barium sulphate, calcium sulphate, magnesium sulphate, calcium carbonate, magnesium carbonate, talc, mica, kaolin, sericite, white mica, synthetic mica, gold mica, red mica, black mica, Lithia mica, silicic acid, silicic anhydride, aluminum silicate, magnesium silicate, aluminum magnesium silicate, calcium silicate, barium silicate, strontium silicate, metal salt of tungstic acid, hydroxyapatite, vermiculite, hydirite, bentonite, montmorillonite, hectorite, zeolite, ceramics powder, dicalcium phosphate, alumina, aluminum hydroxide, boron nitride, and silica, among others. Organic powders that can be used include polyamide powder, polyester powder, polyethylene powder, polypropylene powder, polystyrene powder, polyurethane powder, benzoguanamine powder, polymethyl benzoguanamine powder, polytetrafluoroethylene powder, polymethyl methacrylate powder, cellulose powder, silk powder, 12 nylon, 6 nylon or other nylon powder, polyacrylic powder, polyacrylic elastomer, styrene-acrylate copolymwer, divinyl benzene-styrene copolymer, vinyl resin, urea resin, phenol resin, fluororesin, silicone resin, acrylic resin, melamine resin, epoxy resin, polycarbonate resin, microcrystal fiber powder, starch powder, and lauroyl lysine, among others. Metal salt powders of surface active agent (metal soaps) that can be used include zinc stearate, aluminum stearate, calcium stearate, magnesium stearate, zinc myristate, magnesium myristate, cetyl zinc phosphate, cetyl calcium phosphate, and cetyl sodium zinc phosphate, among others. Colored pigments that can be used include iron oxide, iron hydroxide, iron titanate and other inorganic red pigments; γ-iron oxide and other inorganic brown pigments; yellow iron oxide, yellow ocher and other inorganic yellow pigments; black iron oxide, carbon black and other inorganic black pigments; manganese violet, cobalt violet and other inorganic purple pigments; chrome hydroxide, chrome oxide, cobalt oxide, cobalt titanate and other inorganic green pigments; dark blue, navy blue and other inorganic blue pigments; laked tar dyes, laked natural dyes, and synthetic organic powders comprising the powders of the foregoing, among others. Pearl pigments that can be used include titanium-oxide coated mica, bismuth oxychloride, titanium-oxide coated bismuth oxychloride, titanium-oxide coated talc, scale foil, titanium-oxide coated colored mica, and titanium-oxide/iron-oxide coated mica, among others. Metal powder pigments that can be used include aluminum powder, copper powder, and stainless powder, among others. Tar dyes that can be used include red 3, red 104, red 106, red 201, red 202, red 204, red 205, red 220, red 226, red 227, red 228, red 230, red 401, red 505, yellow 4, yellow 5, yellow 202, yellow 203, yellow 204, yellow 401, blue 1, blue 2, blue 201, blue 404, green 3, green 201, green 204, green 205, orange 201, orange 203, orange 204, orange 206, and orange 207, among others. Natural dyes that can be used include carminic acid, laccaic acid, carsamine, brazilin, and crocin, among others. Under an embodiment of the present invention, any of these ultrafine pigments can be used alone or one or more of them can be selected and combined as deemed appropriate. In particular, ultrafine pigments of titanium dioxide, zinc oxide and silicic anhydride, which have been given surface treatment with monooctyl silane and whose primary particle diameter is in a range of 5 to 50 nm, can be used favorably due to high levels of improvement expected in water repellency.

Silicone resins that can be used under an embodiment of the present invention include, for example, those expressed by the average formula RₙSiO_{(4-n)/2} and having a RRRSiO_{0.5} unit (M unit), RRSiO unit (D unit), RSiO_{1.5} unit (T unit) or SiO₂ unit (Q unit). Preferably, silicone resins conforming to the aforementioned formula, where the average number of n is in a range of 1 to 1.8, should be used. Here, ideally R should be an organic group having an alkyl group of substituted or non-substituted type or linear or branched type and having a carbon number of 1 to 30, phenyl group, amino group, polyether group, sugar derivative, glyceryl group, polyglyceryl group, trifluoropropyl group or perfluoroalkyl group, and R may be one substance or different substances. Other silicone resin compounds that can be used include trimethyl silyl pullulan and other silicone denatured pullulans, and acrylic-silicone copolymer resin and other silicone resin compounds. Of these, acrylic-silicone copolymer resin, fluorine denatured silicone resin, trimethylsiloxysilicate (MQ resin), and dimethyl siloxy group-containing trimethylsiloxysilicate (MDQ resin) are particularly favorable because of their excellent utility. Also, these silicone resins can contain an organic titanate or other catalyst in the composition and crosslinked or cured in a subsequent process by means of heating, UV irradiation or electron beam irradiation. Under an embodiment of the present invention, the silicone resin content should preferably be in a range of 0.1 to 25 parts by weight, or more preferably be in a range of 1 to 15 parts by weight, relative to 100 parts by weight of the composition.

Liquid silicone rubbers that are used under the present invention include, for example, condensation liquid silicone rubbers and addition liquid silicone rubbers. Of the two, condensation liquid silicone rubbers are preferable because they do not produce hydrogen gas during reaction and are therefore safe. Condensation liquid silicone rubbers are classified into the one-liquid type and two-liquid type, of which the one-liquid type is preferable in terms of easier handling. Liquid silicone rubbers may or may not be heated/polymerized, but liquid silicone rubbers that are hardened at normal temperature are preferable as they can be handled easily. Condensation liquid silicone rubbers are classified into the acetic acid type, alcohol type, oxime type, amide type, aminoxy type, acetone type, and dehydrated type, among others, according to the hardening mechanism, and any of the foregoing types can be used without limitation. Liquid silicone rubbers that are used under the present invention may contain various components, such as vinyl methyl silicone rubber, dimethyl silicone rubber, silicone resin containing vinyl group, vinyl phenyl methyl linear siloxane, methyl hydrogen polysiloxane and other silicones; or benzoyl peroxide, tertiary butyl peroxide, sulfur, alkoxysilane, ethyl titanate, butyl titanate and other organic titanates.

As for the volatile solvent used under an embodiment of the present invention, solvents having good dispersibility of ultrafine pigments surface-treated with monooctyl silane as well as good compatibility with silicone resins and/or liquid silicone rubber are preferable. Examples include methanol, ethanol, propanol, isopropanol and other lower alcohols; cyclic silicone, methyl trimethicone, volatile linear dimethyl polysiloxane and other volatile silicones; n-hexane, cyclohexane, toluene, xylene, acetone, petroleum ether, LPG, isododecane, propane, butane, isoparaffin and other petroleum materials; turpentine and other natural components; N-methyl pyrrolidone, fluorocarbon, alternative CFCs, and perfluoropolyether, among others. Among these, selecting one or more of ethanol, isopropanol and volatile silicone is preferable in order to ensure safety of the operator during applicable work. Under an embodiment of the present invention, the volatile solvent content should preferably be in a range of 0.1 to 99 parts by weight, or more preferably be in a range of 30 to 90 parts by weight, relative to 100 parts by weight of the composition. If the volatile solvent content is less than 0.1 part by weight, the solution viscosity of the composition containing ultrafine pigment becomes too high, which makes it difficult to adjust the formed film uniformly and thereby leads to coating problems. If the content exceeds 99 parts by weight, on the other hand, the film becomes too thin after the volatile solvent evaporates, and sufficient coating film strength cannot be achieved as a result.

The high water-repellent composition proposed by an embodiment of the present invention can use, in addition to the aforementioned components, fillers, oil agents, preservatives, antifungal agents, bactericides, UV absorbents, colorants, antioxidants, photosensitizers, polymerization initiators and other components as deemed necessary.

The high water-repellent composition proposed by an embodiment of the present invention contains a ultrafine pigment whose surface is treated with monooctyl silane to a range of 40 to 80 percent by weight relative to the weight of all composition components excluding the volatile solvent. If the ultrafine pigment content is less than 40 parts by weight, water repellency drops. If the content exceeds 80 percent by weight, on the other hand, the viscosity of the composition becomes too high or agglutination of ultrafine pigment occurs when the volatile solvent evaporates, thereby creating cracks and unevenness on the coating film surface.

Under an embodiment of the present invention, “high water repellency” is defined as having super water repellency represented by a contact angle of 135 degrees or more, or preferably 140 degrees or more, between the coating film and purified water. The contact angle should preferably be measured using a commercially available contact-angle measuring apparatus, such as the DM500 contact-angle measuring apparatus manufactured by Kyowa Interface Science. Under an embodiment of the present invention, the contact angle should preferably be measured within 10 seconds after a water droplet makes contact with the measurement sample. If the contact angle is measured after 10 or more seconds, wetting of the surface and other uncertain factors that influence the result will increase and quantifiable results may not be obtained.

The high water-repellency composition used under an embodiment of the present invention is produced by mixing the aforementioned components using a mixer or other mixing apparatus. If a ultrafine pigment with a small primary particle diameter in a range of 1 nm to 100 nm is used, it is preferable to give pretreatment to the ultrafine pigment using a sand mill, bead mill, roll mill, etc., so as to achieve high dispersion of the pigment in the volatile solvent, etc. If any ultrafine pigment having high agglutination property is used in powder form, it is preferable to employ a method whereby the surface of the ultrafine pigment is treated using a surface treatment agent to increase dispersion stability, a method whereby the dispersion stability of the ultrafine pigment is increased using a surface active agent, or a method whereby mechanical dispersion force is used. If mechanical dispersion force is used to mix the aforementioned components, preferably a process should be introduced where an attritor, bead mill or other apparatus capable of applying high dispersion force on ultrafine pigment is used. When a ultrafine pigment is used, better water repellency can be achieved when dispersion is implemented mechanically.

The high water-repellent composition proposed by the present invention represents a high water-repellent composition formed by the aforementioned components, or it is also possible to form a high water-repellent composition by producing a first liquid or paste composition that contains in a dispersed state at least one type of ultrafine pigment whose primary particle diameter is in a range of 1 nm to 15 μm and whose surface is treated with monooctyl silane, and a second composition containing at least one type of silicone compound selected from a silicone resin and/or liquid silicone rubber, and then mixing the two compositions at the time of use.

Here, the dispersed state mentioned above refers to a condition where a ultrafine pigment whose primary particle diameter is in a range of 1 nm to 15 μm and whose surface is treated with monooctyl silane is mechanically dispersed in a solvent or oil solution, or where the aforementioned ultrafine pigment can be dispersed again with ease or relative ease by means of shaking or agitation. Methods of mechanical dispersion include those that use a homomixer, mixer, disper, homogenizer, roll mill, paint shaker, attritor, bead mill, ultrasonic disperser or other dispersion apparatus or grinding apparatus. A surface active agent, thickening agent, dispersion stabilizer or other additive may be blended during dispersion. If an oil solution is used, ester oil, silicone oil, dry oil, mineral oil and various other oils can be used, among which silicone oil is particularly preferable because it has good compatibility with monooctyl silane.

The high water-repellent composition used under an embodiment of the present invention can be sprayed using a spray, etc., or coated using a brush, applicator, etc. Alternatively, a material to be coated can be soaked in the composition, or a thin film can be produced using a spin coater and other apparatuses. It is also possible to add heating, light irradiation, decompression, UV irradiation, electron beam irradiation, etc., as necessary, after coating.

The high water-repellent composition used under an embodiment of the present invention is suitable as a paint, ink, adhesive, coating agent, sealant, etc. Among these, the composition is particularly suitable as a paint, ink, coating agent, or sealant.

In the present disclosure where conditions and/or compositions are not specified, the skilled artisan in the art can readily provide such conditions and/or compositions, in view of the present disclosure, as a matter of routine experimentation.

Embodiments of the present invention is explained specifically below using examples and comparative examples.

The method used to evaluate the water repellency of base material surface coated in the examples and comparative examples is explained below.

<Evaluation Method for Contact Angle>

Purified water was dripped onto the surface of the base material in air using a contact-angle measuring apparatus (DM500 contact-angle measuring apparatus manufactured by Kyowa Interface Science), and the data taken immediately after the base material came in contact with a water droplet was used to obtain the contact angle.

### EXAMPLE 1

A silica with an average primary particle diameter of 11 μm was surface-treated with octyl trimethoxy silane to a concentration of 10 percent by weight. The obtained surface-treated silica was then dispersed in a sand mill, which is a type of bead mill, in decamethyl cyclopentasiloxane, which is a volatile solvent and type of cyclic silicone, until the pigment concentration became 25 percent by weight, to obtain a slurry. Next, the aforementioned slurry was mixed with a 50 percent by weight decamethyl cyclopentasiloxane solution of trimethylsiloxysilicate, which is a type of silicone resin, at a ratio of 5 to 5 based on the weight ratio of octyl sililated silica and trimethylsiloxysilicate, after which decamethyl cyclopentasiloxane amounting to one-third the aforementioned mixture by weight was further added and the mixture was agitated well to obtain a high water-repellent composition. The obtained high water-repellent composition was coated on a glass plate using a spin coater operated for 40 seconds at a rotational speed of 4,000 revolutions per minute, after which the glass plate was dried thoroughly at 60° C.

### EXAMPLE 2

The same processing explained in Example 1 was performed, except that the mixing weight ratio of octyl sililated silica and trimethylsiloxysilicate was changed to 8 to 2, and that decamethyl cyclopentasiloxane amounting to 0.11 time their mixture by weight was further added and agitated well.

### COMPARATIVE EXAMPLE 1

The same processing explained in Example 1 was performed, except that the mixing weight ratio of octyl sililated silica and trimethylsiloxysilicate was changed to 2 to 8, and that decamethyl cyclopentasiloxane amounting to 0.67 time their mixture by weight was added and agitated well.

The contact angle between the coating film and purified water was measured in air for the samples obtained by Example 1 (where octyl sililated silica with an average primary particle diameter of 11 μm was used), Example 2 (same as above) and Comparative Example 1 (same as above). The results are shown in Table 1.

TABLE 1

| | Ultrafine | Contact angle |
|---|---|---|
| | pigment ratio | (degrees) |
| Example 2 | 80% | 159.4 |
| Example 1 | 50% | 157.7 |
| Comparative Example 1 | 20% | 114.7 |

The results in Table 1 show that, while the coating film surfaces obtained in Examples 1 and 2 exhibited super water repellency of 140 degrees or more, the coating film surface obtained in Comparative Example 1, where the ultrafine pigment treated with octyl sililated silica was added to 20 percent by weight, did not provide a sufficient contact angle although some water repellency was observed.

### EXAMPLE 3

A silica with an average primary particle diameter of 5 nm was surface-treated with octyl triethoxy silane to a concentration of 10 percent by weight. The obtained surface-treated silica was then dispersed in a sand mill, which is a type of bead mill, in decamethyl cyclopentasiloxane, which is a volatile solvent and type of cyclic silicone, until the pigment concentration became 10 percent by weight, to obtain a slurry. Next, the aforementioned slurry was mixed with a 50 percent by weight decamethyl cyclopentasiloxane solution of trimethylsiloxysilicate, which is a type of silicone resin, at a ratio of 6 to 4 based on the weight ratio of octyl sililated silica and trimethylsiloxysilicate, after which ethanol amounting to 1.78 times the aforementioned mixture by weight was further added and the mixture was agitated well to obtain a high water-repellent composition. The obtained high water-repellent composition was coated on a glass plate using a 0.1-milliinch applicator, after which the glass plate was dried thoroughly at 60° C.

### COMPARATIVE EXAMPLE 2

The same processing explained in Example 3 was performed, except that the mixing weight ratio of octyl sililated silica and trimethylsiloxysilicate was changed to 2.9 to 7.1, and that ethanol amounting to twice their mixture by weight was further added and agitated well.

The contact angle between the coating film and purified water was measured in air for the samples obtained by Example 3 (where octyl sililated silica with an average primary particle diameter of 5 nm was used) and Comparative Example 2 (same as above). The results are shown in Table 2.

TABLE 2

| | Ultrafine | Contact angle |
|---|---|---|
| | pigment ratio | (degrees) |
| Example 3 | 60% | 157.3 |
| Comparative Example 2 | 29% | 129.8 |

The results in Table 2 show that, while the coating film surface obtained in Example 3 exhibited super water repellency of 140 degrees or more, the coating film surface obtained in Comparative Example 2, where the ultrafine pigment treated with octyl sililated silica was added to 29 percent by weight, had a small contact angle and slightly lower level of water repellency.

### EXAMPLE 4

A silica with an average primary particle diameter of 0.25 μm was surface-treated with octyl triethoxy silane to a concentration of 10 percent by weight. The obtained surface-treated silica was then dispersed in a sand mill, which is a type of bead mill, in decamethyl cyclopentasiloxane, which is a volatile solvent and type of cyclic silicone, until the pigment concentration became 50 percent by weight, to obtain a slurry. Next, the aforementioned slurry was mixed with a 50 percent by weight decamethyl cyclopentasiloxane solution of dimethyl polysiloxane-trimethylsiloxysilicate copolymer, which is a type of silicone resin, at a ratio of 8.9 to 1.1 based on the weight ratio of octyl sililated silica and dimethyl polysiloxane-trimethylsiloxysilicate copolymer, after which decamethyl cyclopentasiloxane amounting to 1.5 times the aforementioned mixture by weight was further added and the mixture was agitated well to obtain a high water-repellent composition. The obtained high water-repellent composition was coated on a glass plate using a 0.1-milliinch applicator, after which the glass plate was dried thoroughly at 60° C.

### COMPARATIVE EXAMPLE 3

The same processing explained in Example 4 was performed, except that the mixing weight ratio of octyl sililated silica and dimethyl polysiloxane-trimethylsiloxysilicate copolymer was changed to 3.3 to 6.7, and that decamethyl cyclopentasiloxane amounting to 0.67 time their mixture by weight was further added and agitated well.

The contact angle between the coating film and purified water was measured in air for the samples obtained by Example 4 (where octyl sililated silica with an average primary particle diameter of 0.25 μm was used) and Comparative Example 3 (same as above). The results are shown in Table 3.

TABLE 3

| | Ultrafine | Contact angle |
|---|---|---|
| | pigment ratio | (degrees) |
| Example 4 | 89% | 135.1 |
| Comparative Example 3 | 33% | 111.3 |

The results in Table 3 show that, while the coating film surface obtained in Example 4 exhibited high water repellency of 135 degrees or more in the contact angle of purified water on the coating film surface, the coating film surface obtained in Comparative Example 3, where the ultrafine pigment treated with octyl sililated silica was added to 33 percent by weight, had a small contact angle and lower water repellency.

### EXAMPLE 5

A silica/alumina-treated titanium dioxide with an average primary particle diameter of 35 nm was surface-treated with octyl triethoxy silane to a concentration of 10 percent by weight. The obtained surface-treated titanium dioxide was then dispersed in a sand mill, which is a type of bead mill, in decamethyl cyclopentasiloxane, which is a volatile solvent and type of cyclic silicone, until the pigment concentration became 40 percent by weight, to obtain a slurry. Next, the aforementioned slurry was mixed with a 50 percent by weight decamethyl cyclopentasiloxane solution of trimethylsiloxysilicate, which is a type of silicone resin, at a ratio of 8.7 to 1.3 based on the weight ratio of octyl sililated titanium dioxide and trimethylsiloxysilicate, after which decamethyl cyclopentasiloxane amounting to 1.8 times the aforementioned mixture by weight was further added and the mixture was agitated well to obtain a high water-repellent composition. The obtained high water-repellent composition was coated on a glass plate using a spin coater operated for 40 seconds at a rotational speed of 2,000 revolutions per minute, after which the glass plate was dried thoroughly at 60° C.

### COMPARATIVE EXAMPLE 4

The same processing explained in Example 5 was performed, except that the mixing weight ratio of octyl sililated titanium dioxide and trimethylsiloxysilicate was changed to 2.7 to 7.3, and that decamethyl cyclopentasiloxane amounting to 3.2 times their mixture by weight was further added and agitated well.

The contact angle between the coating film and purified water was measured in air for the samples obtained by Example 5 (where octyl sililated titanium dioxide with an average primary particle diameter of 35 nm was used) and Comparative Example 4 (same as above). The results are shown in Table 4.

TABLE 4

| | Ultrafine | Contact angle |
|---|---|---|
| | pigment ratio | (degrees) |
| Example 5 | 87% | 157.6 |
| Comparative Example 4 | 27% | 111.5 |

The results in Table 4 show that, while the coating film surface obtained in Example 5 exhibited high water repellency of 140 degrees or more in the contact angle of purified water on the coating film surface, the coating film surface obtained in Comparative Example 4, where the ultrafine pigment treated with octyl sililated titanium dioxide was added to 27 percent by weight, had a small contact angle and lower water repellency.

### EXAMPLE 6

A metal cube was soaked in the high water-repellent composition obtained in Example 5, after which the cube was removed and dried well at 60° C. The metal cube exhibited very high water repellency.

### EXAMPLE 7

A resin plate was coated with the high water-repellent composition obtained in Example 5 using a brush, after which the plate was dried well at 60° C. The resin plate exhibited super water repellency.

A silica-alumina treated titanium dioxide with an average particle diameter of 35 nm was further surface-treated with octyl triethoxysilane at a concentration of 10 percent by weight. The obtained titanium dioxide was dispersed in a decamethyl cyclopentasiloxane so that the pigment concentration became 40 percent by weight, and then the dispersion was crushed with a disper operated at a speed of 5,300 rpm to obtain a slurry. Next, 42 parts by weight of a one-liquid RTV rubber (SE9140RTV manufactured by Toray Dow Corning; alcohol-free type with a dry residue content at 105° C. of 96 percent by weight), which is a type of condensation liquid silicone rubber, were mixed with 150 parts by weight of the aforementioned slurry using a disper, to obtain a composition constituted by the aforementioned octyl sililated titanium dioxide and liquid silicone rubber being mixed at a ratio of 60 to 40 by weight. This composition was coated on a resin film (manufactured by A-PET) to a film thickness of 5 milli-inches using an applicator, and dried well at 40° C.

### EXAMPLE 9

Using the slurry obtained in Example 8, 80 parts by weight of a one-liquid RTV rubber (SH237 manufactured by Toray Dow Corning; acetate-free type with a dry residue content at 105° C. of 50 percent by weight), which is a type of condensation liquid silicone rubber, were mixed well with 150 parts of the slurry using a spatula, to obtain a composition constituted by the aforementioned octyl sililated titanium dioxide and liquid silicone rubber being mixed at a ratio of 60 to 40 by weight. This composition was coated on a resin film (manufactured by A-PET) to a film thickness of 5 milli-inches using an applicator, and dried well at 40° C. For your information, this example assumes that the operator would carry out the mixing on site at the time of use.

### EXAMPLE 10

Using the slurry obtained in Example 8, 66 parts by weight of a one-liquid RTV rubber (SE5070 manufactured by Toray Dow Corning; oxime-free type with a dry residue content at 105° C. of 61 percent by weight), which is a type of condensation liquid silicone rubber, were mixed with 150 parts of the slurry using a disper, to obtain a composition constituted by the aforementioned octyl sililated titanium dioxide and liquid silicone rubber being mixed at a ratio of 60 to 40 by weight. This composition was coated on a resin film (manufactured by A-PET) to a film thickness of 5 milli-inches using an applicator, and dried well at 40° C.

### EXAMPLE 11

Using the slurry obtained in Example 8, 21 parts by weight of a one-liquid RTV rubber (SE9140RTV manufactured by Toray Dow Corning), which is a type of condensation liquid silicone rubber, were mixed with 200 parts of the slurry using a disper, to obtain a composition constituted by the aforementioned octyl sililated titanium dioxide and liquid silicone rubber being mixed at a ratio of 80 to 20 by weight. This composition was coated on a resin film (manufactured by A-PET) to a film thickness of 5 milli-inches using an applicator, and dried well at 40° C.

### COMPARATIVE EXAMPLE 5

Using the slurry obtained in Example 8, 167 parts by weight of a one-liquid RTV rubber (SE9140RTV manufactured by Toray Dow Corning), which is a type of condensation liquid silicone rubber, were mixed well with 100 parts of the slurry using a spatula, to obtain a composition constituted by the aforementioned octyl sililated titanium dioxide and liquid silicone rubber being mixed at a ratio of 20 to 80 by weight. This composition was coated on a resin film (manufactured by A-PET) to a film thickness of 5 milli-inches using an applicator, and dried well at 40° C.

### COMPARATIVE EXAMPLE 6

A one-liquid RTV rubber (SE9140RTV manufactured by Toray Dow Corning), which is a type of condensation liquid silicone rubber, was directly applied on a resin film (manufactured by A-PET) to a film thickness of 5 milli-inches using an applicator, and dried well at 40° C.

### COMPARATIVE EXAMPLE 7

A one-liquid RTV rubber (SH237 manufactured by Toray Dow Corning), which is a type of condensation liquid silicone rubber, was directly applied on a resin film (manufactured by A-PET) to a film thickness of 5 milli-inches using an applicator, and dried well at 40° C.

Table 5 lists the contact angles measured between the coating film and purified water for the samples obtained by Examples 8 to 11 and Comparative Examples 5 to 7.

TABLE 5

| Specimen | Contact angle (degrees) |
|---|---|
| Example 8 | 152.1 |
| Example 9 | 149.0 |
| Example 10 | 148.5 |
| Example 11 | 153.8 |
| Comparative Example 5 | 113.7 |
| Comparative Example 6 | 114.0 |
| Comparative Example 7 | 116.4 |

The results in Table 5 show that the coating films obtained in all Examples exhibited very large contact angles roughly corresponding to super water repellency. On the other hand, the coating film obtained in Comparative Example 5 had a small contact angle. In Comparative Examples 6 and 7, where resins used in Examples were coated directly, the contact angles were both small. This suggests that by using a ultrafine pigment whose surface is treated with monooctyl silane, the water repellency of the liquid silicone rubber improved significantly.

### EXAMPLE 12

The high water-repellent composition obtained in Example 8 was coated on a strain gauge (strain measurement sensor) affixed on a substrate. The coated gauge was dried, and then soaked in a 3% salt water, after which the gauge was stored for one month at 40° C. When the condition of coating film was observed after the storage period, no visible cracks, peels and distortions were found. This high water-repellent composition also exhibited excellent durability.

### SUMMARY OF RESULTS

When the above examples and comparative examples are compared, it is clear that a large contact angle and improved water repellency can be achieved by using a ultrafine pigment whose surface is treated with monooctyl silane to a range of 1 to 20 parts by weight and whose primary particle diameter is in a range of 1 nm to 15 μm, and by adjusting the content of the ultrafine pigment surface-treated with monooctyl silane to a range of 40 to 80 percent by weight relative to the weight of the composition excluding the volatile solvent.

Although all possible variations are not listed herein, the present invention can be embodied in any modes incorporating various changes, modifications and improvements based on the knowledge of those skilled in the art. It goes without saying that these embodiments are also included in the scope of the present invention, as long as they do not deviate from the purpose of the present invention. Therefore, it should be clearly understood that the forms of the present invention are illustrative only and are not intended to limit the scope of the present invention.

The present application claims priority to Japanese Patent Application No. 2006-252616, filed Sep. 19, 2006, and No. 2007-227523, filed Sep. 3, 2007, the disclosure of which is incorporated herein by reference in their entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A high water-repellent composition comprising:
at least one type of ultrafine pigment whose surface is treated with a monooctyl silane and whose primary particle diameter is in a range of 1 nm to 15 Jim,
at least one type of silicone compound selected from the group consisting of silicone resins and liquid silicone rubbers, and
a volatile solvent,
wherein the content of the ultrafine pigment surface-treated with monooctyl silane is in a range of 40 to 80 percent by weight relative to the weight of the composition excluding the volatile solvent.

2. The high water-repellent composition according to claim 1, wherein the silicone compound is a silicone resin expressed by the average formula RₙSiO_{(4-n)/2} where R is an organic group having an alkyl group of substituted or non-substituted type or linear or branched type and having a carbon number of 1 to 30, phenyl group, amino group, polyether group, sugar derivative, glyceryl group, polyglyceryl group, trifluoropropyl group or perfluoroalkyl group, and where the average number of n is in a range of 1 to 1.8.

3. The high water-repellent composition according to claim 1, wherein the silicone compound is a liquid silicone rubber selected from condensation liquid silicone rubbers.

4. The high water-repellent composition according to claim 1, wherein the ultrafine pigment is included in a first component in form of liquid or paste in which the ultrafine pigment is dispersed, and the silicone compound is included in a second component,
wherein the high water-repellent composition is a mixture of the first and second components being mixed when in use.

5. A paint, ink, coating agent, or sealant comprising the high water-repellent composition according to claim 1.

6. The high water-repellent composition according to claim 2, wherein the silicone compound is a silicone resin expressed by the average formula RₙSiO_{(4-n)/2} where R is an organic group having an alkyl group of substituted or non-substituted type or linear or branched type and having a carbon number of 1 to 30, phenyl group, amino group, polyether group, sugar derivative, glyceryl group, polyglyceryl group, trifluoropropyl group or perfluoroalkyl group, and where the average number of n is in a range of 1 to 1.8.

7. The high water-repellent composition according to claim 2, wherein the ultrafine pigment is included in a first component in form of liquid or paste in which the ultrafine pigment is dispersed, and the silicone compound is included in a second component.

8. The high water-repellent composition according to claim 3, wherein the ultrafine pigment is included in a first component in form of liquid or paste in which the ultrafine pigment is dispersed, and the silicone compound is included in a second component.

9. The high water-repellent composition according to claim 6, wherein the ultrafine pigment is included in a first component in form of liquid or paste in which the ultrafine pigment is dispersed, and the silicone compound is included in a second component.

10. A paint, ink, coating agent, or sealant comprising the high water-repellent composition according to claim 2.

11. A paint, ink, coating agent, or sealant comprising the high water-repellent composition according to claim 3.

12. A paint, ink, coating agent, or sealant comprising the high water-repellent composition according to claim 4.

13. A paint, ink, coating agent, or sealant comprising the high water-repellent composition according to claim 6.

14. A paint, ink, coating agent, or sealant comprising the high water-repellent composition according to claim 7.

15. A paint, ink, coating agent, or sealant comprising the high water-repellent composition according to claim 8.

16. A paint, ink, coating agent, or sealant comprising the high water-repellent composition according to claim 9.

17. A water-repellent composition having a contact angle of 135° or higher against distilled water at room temperature, comprising:
a first component containing at least one ultrafine pigment dispersed therein composed of fine particles each having a surface treated with a monooctyl silane and having an average primary particle diameter in a range of 1 nm to 15 μm; and
a second component containing at least one silicone compound selected from the group consisting of silicone resins and liquid silicone rubbers; and
wherein the ultrafine pigment is contained in an amount of 40% to 80% by weight of the composition.

18. The water-repellent composition according to claim 17, wherein 100 parts by weight of the fine particles are treated with 1-20 parts by weight of the monooctyl silane.

19. The water-repellent composition according to claim 17, wherein the silicone compound is a silicone resin expressed by general formula RₙSiO_{(4-n)/2} where R is an organic group having an alkyl group of substituted or non-substituted type or linear or branched type and having a carbon number of 1 to 30, phenyl group, amino group, polyether group, sugar derivative, glyceryl group, polyglyceryl group, trifluoropropyl group, or perfluoroalkyl group, and n is 1 to 1.8 on average.

20. The water-repellent composition according to claim 17, which has a contact angle of 140° or higher against distilled water at room temperature.

21. The water-repellent composition according to claim 17, wherein the first component is in form of liquid or paste.

22. The water-repellent composition according to claim 17, wherein the ultrafine pigment is dispersed in the first component using a volatile solvent.
